(19) United States
(12) Patent Application Publication
(10) Pub. No.: US 2024/0097241 A1
(43) Pub. Date: Mar. 21, 2024

(54) Facility for High Capacity Storage Using Metal Hydrogen Batteries

(71) Applicant: EnerVenue, Inc, Fremont, CA (US)

(72) Inventors: Majid Keshavarz, Pleasanton, CA (US); Ge Zu, San Jose, CA (US); Nelson Dichter, Oakland, CA (US)

(21) Appl. No.: 17/947,978

(22) Filed: Sep. 19, 2022

(51) Int. Cl. H01M 12/02; H01M 4/86; H01M 12/06; H01M 50/224; H01M 50/231

(52) U.S. Cl. CPC H01M 12/02; H01M 4/8605; H01M 12/06; H01M 50/224; H01M 50/231; H01M 2250/10

(57) ABSTRACT

In accordance with embodiments of the present disclosure, an electrical storage facility is presented. The electrical storage facility includes an outer shell, the outer shell containing a hydrogen gas; a battery pack rigidly mounted within the outer shell, the battery pack including an array of metal hydrogen batteries; and a monitor/control system coupled to each of the metal hydrogen batteries in the array of individual metal hydrogen batteries. In some embodiments, the electrical storage facility contains low pressure hydrogen gas.

### TECHNICAL FIELD

This disclosure is generally related to metal hydrogen batteries, and more particularly to facilities using metal hydrogen batteries.

### BACKGROUND

For renewable energy resources such as wind and solar to be competitive with traditional fossil fuels, large-scale energy storage systems are needed to mitigate their intrinsic intermittency. To build a large-scale energy storage, the cost and long-term lifetime are the utmost considerations. Currently, pumped-hydroelectric storage dominates the grid energy storage market because it is an inexpensive way to store large quantities of energy over a long period of time (about 50 years), but it is constrained by the lack of suitable sites and the environmental footprint. Other technologies such as compressed air and flywheel energy storage show some different advantages, but their relatively low efficiency and high cost should be significantly improved for grid storage. Rechargeable batteries offer great opportunities to target low-cost, high capacity and highly reliable systems for large-scale energy storage.

### SUMMARY

In accordance with embodiments of the present disclosure, an electrical storage facility is presented. The electrical storage facility includes an outer shell, the outer shell containing a hydrogen gas; a battery pack rigidly mounted within the outer shell, the battery pack including an array of metal hydrogen batteries; and a monitor/control system coupled to each of the metal hydrogen batteries in the array of individual metal hydrogen batteries. In some embodiments, the electrical storage facility contains low pressure hydrogen gas.

A method of providing energy storage includes providing an outer shell that contains a hydrogen gas; mounting a battery pack within the outer shell, the battery pack including an array of metal hydrogen batteries; and monitoring the battery pack with a monitor/control system coupled to each of the metal hydrogen batteries in the array of individual metal hydrogen batteries.

Other embodiments are contemplated and explained herein after.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the disclosure are utilized, and the accompanying drawings of which:

FIGS. 1A, 1B, 1C, and 1D illustrate various sized facilities for energy storage according to some embodiments.

FIGS. 2A and 2B depict a schematic of a metal-hydrogen battery that can be used in the facilities illustrated in FIG. 1.

FIG. 3 illustrates an array of batteries as illustrated in FIG. 2 to form a battery pack as illustrated in FIGS. 1A, 1B, 1C, and 1D.

FIG. 4 illustrates an example of an energy storage facility according to some embodiments.

FIG. 5 illustrates hydrogen pressure cycling profiles at different pressure setups in a pressure vessel according to some embodiments over time.

FIGS. 6A and 6B illustrate battery performance comparisons of some embodiments over various pressure ranges.

FIGS. 7A and 7B illustrate 5-vessel shared pressure vessel (SPV) performance at 50-150 psi hydrogen ranges according to some embodiments over numbers of cycles.

### DETAILED DESCRIPTION OF EMBODIMENTS

In the following description, certain specific details are set forth in order to provide a thorough understanding of various embodiments of the disclosure. However, one skilled in the art will understand that the disclosure may be practiced without these details. Moreover, while various embodiments of the disclosure are disclosed herein, many adaptations and modifications may be made within the scope of the disclosure in accordance with the common general knowledge of those skilled in this art. Such modifications include the substitution of known equivalents for any aspect of the disclosure in order to achieve the same result in substantially the same way.

Unless the context requires otherwise, throughout the present specification and claims, the word “comprise” and variations thereof, such as, “comprises” and “comprising” are to be construed in an open, inclusive sense, that is as “including, but not limited to.” Recitation of numeric ranges of values throughout the specification is intended to serve as a shorthand notation of referring individually to each separate value falling within the range inclusive of the values defining the range, and each separate value is incorporated in the specification as it were individually recited herein. Additionally, the singular forms “a,” “an” and “the” include plural referents unless the context clearly dictates otherwise.

Reference throughout this specification to “one embodiment” or “an embodiment” means that a particular feature, structure or characteristic described in connection with the embodiment is included in at least one embodiment of the present disclosure. Thus, the appearances of the phrases “in one embodiment” or “in an embodiment” in various places throughout this specification are not necessarily all referring to the same embodiment, but may be in some instances. Furthermore, the particular features, structures, or characteristics may be combined in any suitable manner in one or more embodiments.

Embodiments of the present disclosure describes an electrode for a metal-hydrogen battery formed from one or more porous layers. Each of the porous layers includes a porous substrate and a catalyst layer covering the porous substrate, the catalyst layer including a transition metal. At least one of the one or more porous layer includes a surface with features that facilitate hydrogen gas transport. In some embodiments, an anode electrode includes a first porous layer having a first surface; and a second porous layer adjacent the first porous layer having a second surface, wherein the first surface of the first porous layer and the second surface of the second porous layer form hydrogen gas transport channels.

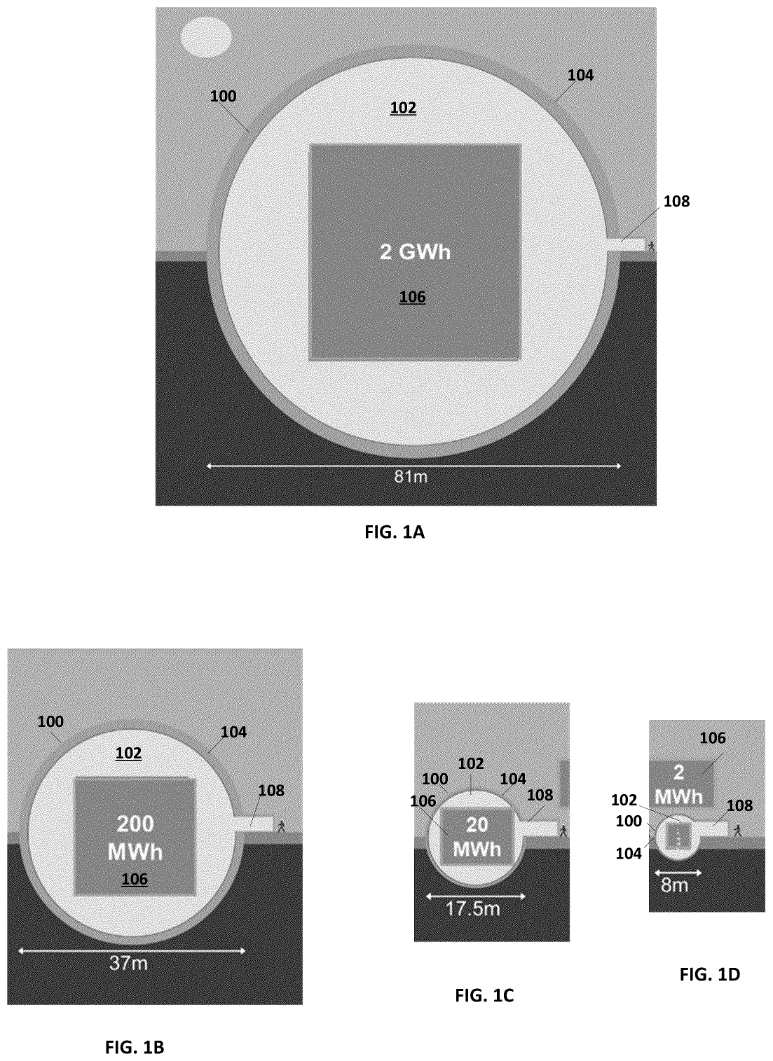

FIG. 1A illustrates a storage facility 100 according to some embodiments of the present disclosure. As illustrated in FIG. 1A, storage facility 100 includes an outer shell 104 that encloses a battery pack 106. Outer shell 104 can be a large spherical shell, large enough to enclose the battery pack 106. Battery pack 106 occupy a portion of the interior space 102, which is also filled with hydrogen gas. In some embodiments, battery pack 106 may be outside of interior space 102 in a separate enclosure coupled with interior space 102. In some embodiments, an entrance 108 allows access to the interior of storage facility 100, which may be important for maintenance, assembly, or other activities. As is further illustrated in FIG. 1A, outer shell 104 of storage facility 100 may be at least partially below ground, although the entire facility may be either completely above ground or completely below ground.

Embodiments storage facility 100 illustrated in FIGS. 1A, 1B, 1C, and 1D include outer shells 104 that are spherical in shape. However, other shapes such as rectangular or cylindrical may also be utilized. Outer shell 104 can be formed of concrete or other suitable structural material. In some embodiments, outer shell 104 may be formed of materials configured to contain hydrogen gas. In some embodiments, outer shell 104 may include a liner, either formed within outer shell 104 or around the outer surface of outer shell 104, that assists in containing hydrogen gas within interior space 102.

FIGS. 1A, 1B, 1C, and 1D illustrate relative sizes of storage facility 100 in comparison with the electrical storage capabilities of facility 100. FIG. 1A shows an example of a 2 GWh facility, which may in some embodiments include an outer shell 104 with outer diameter of 81 m. In these embodiments, the size of outer shell 104 depends on the physical size of battery pack 106 and the volume and the pressure of hydrogen gas storage capacity needed for operation of battery pack 106. In some embodiments, the size of battery pack 106 may further include maintenance access to service battery pack 106. FIG. 1B illustrates a storage facility 100 of 200 MWh, which in scaling with the 2 GWh facility illustrated in FIG. 1A, may have an outer shell 104 of outer diameter 37 m. FIG. 1C illustrates a storage facility 100 of 20 MWh, which may have an outer shell 104 of outer diameter 17.5 m. FIG. 1D illustrates a storage facility 100 of 2 MWh, which may have an outer shell 104 of outer diameter 8 m. These specific examples are provided for illustrative purposes only and, as discussed above, is limited only by the size of battery pack 106 and the amount and pressure of hydrogen gas storage used to operate battery pack 106. The size and structure of the storage facility can be calculated so that the operating hydrogen pressure is not exceeding the maximum allowable design pressure, e.g. a low pressure of 500 psi or less, 200 psi or less, or 100 psi or less.

Battery pack 106 as illustrated in FIGS. 1A, 1B, 1C, and 1D can be formed by arrays of individual batteries. These individual batteries may be arranged in arrays and coupled in parallel and/or series configurations according to the output voltage and current requirements of storage facility 100. The overall storage capacity is determined by the number of individual batteries included in battery pack 106.

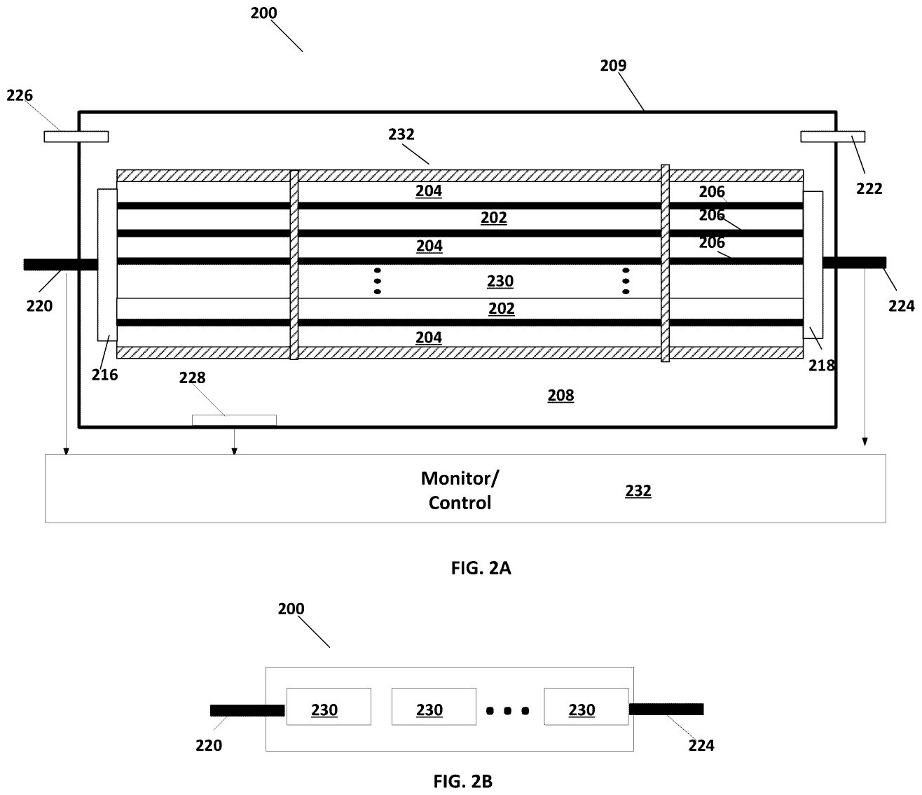

FIGS. 2A and 2B depicts a schematic depiction of a metal-hydrogen battery 200 that can be used in battery pack 106. As shown in FIG. 2A, the metal-hydrogen battery 200 includes electrode stack assembly 230 that includes stacked electrodes that are separated by separators 206. The electrode stack assembly 230 includes alternately stacked cathode electrodes 202 and anode electrodes 204. Cathode electrodes 202 and anode electrodes 204 are separated by separators 206 that are disposed between them. Separator 206 can be saturated with an electrolyte 208. In some embodiments, separator 206, in addition to electrically separating cathode electrodes 202 from anode electrodes 204, provides a reservoir of electrolyte 208 that buffers the electrodes from either drying out or flooding during operation of battery 200.

As illustrated in FIG. 2A, the electrode stack assembly 230 can be housed in a container 209. As illustrated, an electrolyte 208 is disposed in container 209 such that stack 230 is saturated with electrolyte 208. The cathode electrode 202, the anode electrode 204, and the separator 206 are porous to hold electrolyte 208 and allow ions in electrolyte 208 to transport between the cathode electrodes 202 and the anode electrodes 204. In some embodiments, the separator 206 can be omitted as long as the cathode electrodes 202 and the anode electrodes 204 can be electrically insulated from each other and sufficient electrolyte 208 can be held in electrode stack 230. For example, the space occupied by the separator 206 may be filled with the electrolyte 208.

The metal-hydrogen battery 200 illustrated in FIG. 2A can further include one or more fill tubes 222 and 226 configured to introduce electrolyte or gasses (e.g. hydrogen gas) into container 209. In some embodiments, container 209 may be any material that contains electrolyte 208 but is porous to hydrogen gas flow. For example, container 209 may be a plastic bag or plastic container into which electrode stack 230 is placed. Fill tubes 222 and 226 may include one or more valves (not shown) to control hydrogen gas flow into and out of the enclosure of container 209 or fill tubes 222 and 226 may be otherwise sealable after charging container 209 with electrolyte 208 and possibly hydrogen gas. In some embodiments, a valve can be formed of a material porous to hydrogen gas and impervious to liquid. In some embodiments, container 209 may include multiple ones of electrode stack 230.

As shown in FIG. 2A and discussed above, electrode stack assembly 230 includes a number of stacked layers of alternating cathode electrodes 202 and anode electrodes 204 separated by separators 206. Although the electrodes in an electrode stack assembly 230 may be coupled either in parallel or in series, in the example of battery 200 illustrated in FIG. 2A the electrodes are coupled in parallel. In particular, each of cathode electrodes 202 are coupled to a conductor 218 and each of anode electrodes 204 are coupled to conductor 216. Although FIG. 2A illustrates that fill tubes 222 and 226 are positioned on the ends, fill tubes 222 and 226 may alternatively be placed anywhere on container 202. In some embodiments, battery 200 may include only one of fill tubes 222 and 226.

As is further illustrated in FIG. 2A, conductor 216, which is coupled to anode electrodes 204, is electrically coupled to feedthrough terminal 220, which may present one terminal of battery 200. Terminal 220 can include a feedthrough to allow terminal 220 to extend outside of container 209. Similarly, conductor 218, which is coupled to cathode electrodes 202, can be coupled to a feedthrough terminal 224 that represents the opposite (positive) terminal of battery 200. Terminal 224 also pass through an insulated feedthrough to allow terminal 224 to extend to the outside of container 209, because terminal 224 is coupled to the cathode electrodes 204.

As is illustrated in FIG. 2A, electrode stack 204 can be fixed within a frame 232. In FIG. 2A electrode stack assembly 230 can be organized with anode electrodes 204 on both sides adjacent to frame 232, in order to isolate cathode electrodes 202 from frame 232. In some embodiments, a separator 206 can be included adjacent to frame 232 for further isolation, especially if electrode stack assembly 230 is arranged such that cathode electrodes 202 are adjacent to frame 232 rather than anode electrodes 204.

As discussed above, electrode stack 230 includes alternating layers of cathode electrodes 202 and anode electrodes 204 that are separated by separators 206. Electrode stack assembly 230 is positioned in container 209 and contains an electrolyte 208 where ions in electrolyte 208 can transport between cathode electrodes 202 and anode electrodes 204. Separator 206 can be a porous insulator. In some embodiments, the electrolyte 208 is an aqueous electrolyte that is alkaline (with a pH greater than 7).

Examples of battery 200 as illustrated in FIG. 2 are discussed in further detail in, for example, U.S. patent application Ser. No. 17/687,527 filed on Mar. 4, 2022, entitled “Electrode Stack Assembly for a Metal Hydrogen Battery;” U.S. Pat. Appl. 63/347,908, filed on Jun. 1, 2022, entitled “Electrode Stack Assembly for a Metal Hydrogen Battery;” and U.S. patent application Ser. No. 17/847,591, filed on Jun. 23, 2022, entitled “Electrode for Metal Hydrogen Battery and Method for Manufacturing Same,” each of which is herein incorporated by reference in its entirety.

As is further illustrated in FIG. 2A, battery 200 can be coupled to a monitor/control system 232. Battery 200 can include sensors 228 that provide signals related, for example, to the state of the electrolyte 208 in electrode stack 230 of battery 200, to monitor/control system 232. Further, electrodes 220 and 224 may also be monitored such that monitor/control system 232 can determine performance parameters such as state-of-charge and other parameters. Consequently, monitor/control system 232 can determine the efficiency of battery 200 and indicate whether battery 200 is performing within acceptable parameters or whether battery 200 is failing.

In some embodiments, as illustrated in FIG. 2B, battery 200 can include a plurality of electrode stacks 230 in each housing 209. Configurations such as this are further illustrated in U.S. patent application Ser. No. 17/898,098 filed on Aug. 29, 2022, and entitled “Nickel-Hydrogen Battery Configurations for Grid-Scale Energy Storage,” which is herein incorporated by reference in its entirety.

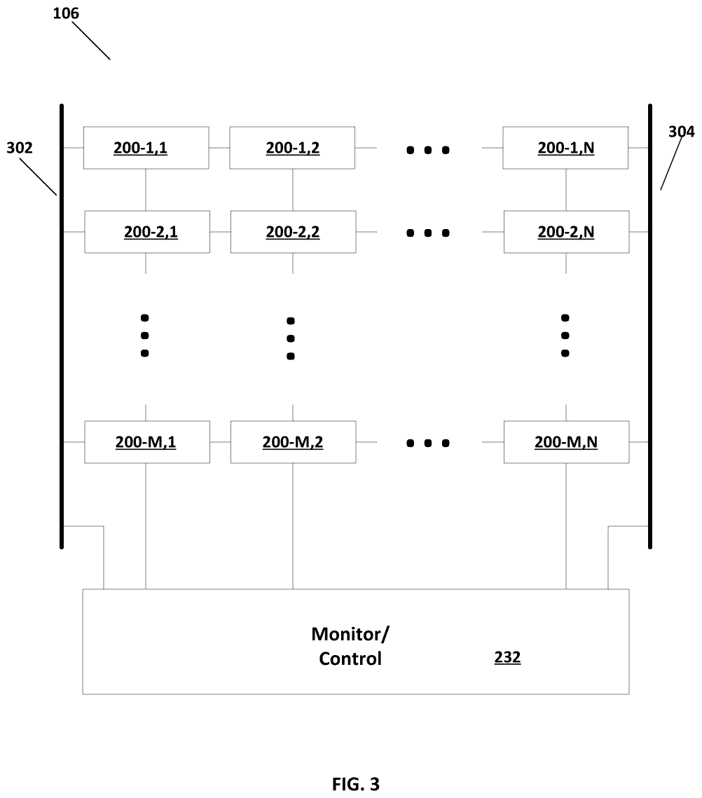

FIG. 3 illustrates an example of battery pack 106 formed from batteries 200-1,1 through 200-M,N. As is illustrated, battery pack 106 includes M rows of N series coupled batteries 200. Each of the M rows are coupled in parallel between facility terminals 302 and 304. Consequently, batteries 200-1,1 through 200-1,N are coupled in series and the row is coupled in parallel with series-coupled batteries 200-m,1 through 200-m,N. Each of batteries 200-1,1 through 200-M,N can be battery 200 as described in FIG. 2.

As is further illustrated in FIG. 3, monitor/control system 232 is coupled to monitor each of batteries 200-1,1 through 200-M,N. Monitor/control system 232 can also monitor facility terminals 302 and 304 to monitor the performance of battery pack 106. As discussed above, monitor/control system 232 can monitor each of batteries 200-1,1 and 200-M,N and can determine if one or more of them are failing and require maintenance.

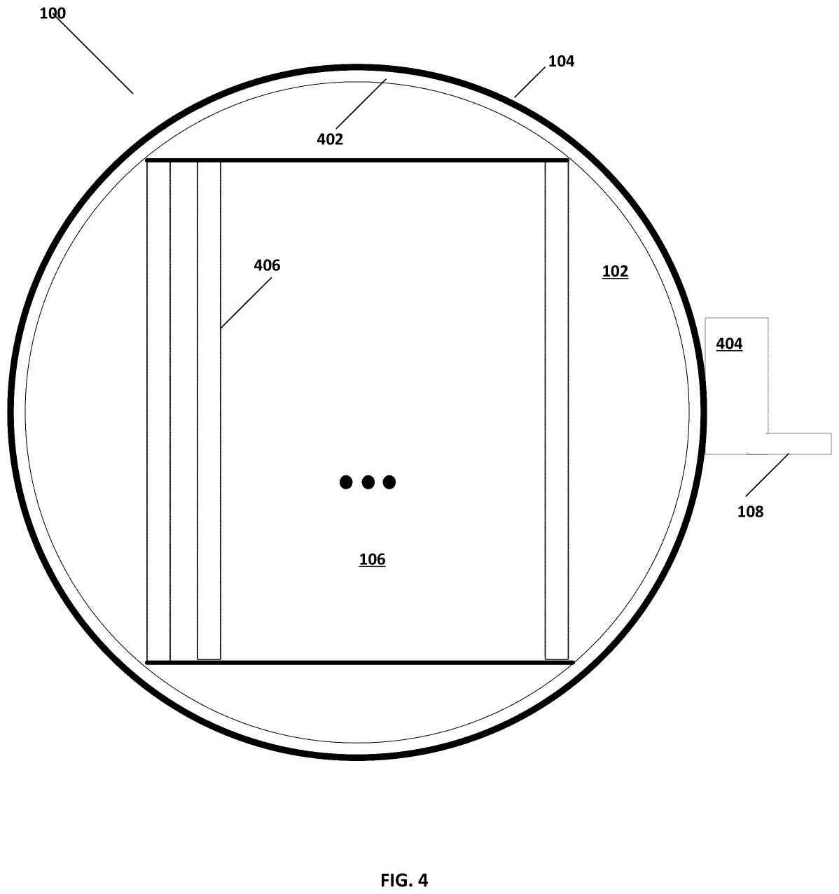

FIG. 4 illustrates an embodiment of facility 100 as illustrated in FIGS. 1A, 1B, 1C, and 1D. As illustrated in FIG. 4, outer shell 104 may be a rigid outer sphere. As discussed above, outer shell 104 is configured to contain hydrogen at operating pressures and temperature in interior space 102. In some embodiments, a liner 402, which can be formed of a material that contains hydrogen, is formed on the interior or exterior surface of outer shell 104. Liner 402 may be formed, for example, of a plastic material such as polyethylene. In some embodiments, liner 402 can be metallic or a metallic alloy, for example stainless steel.

As is further illustrated in FIG. 4, battery pack 106 includes a rack 406 on which batteries 200-1,1 through 200-M,N are mounted. Rack 406 can be any structure that rigidly holds batteries 200-1,1 through 200-M,N. In some embodiments, rack 406 can be arranged to allow for servicing. As is further illustrated in FIG. 4, entrance 108 can include a control room 404, which may include monitor/control system 232.

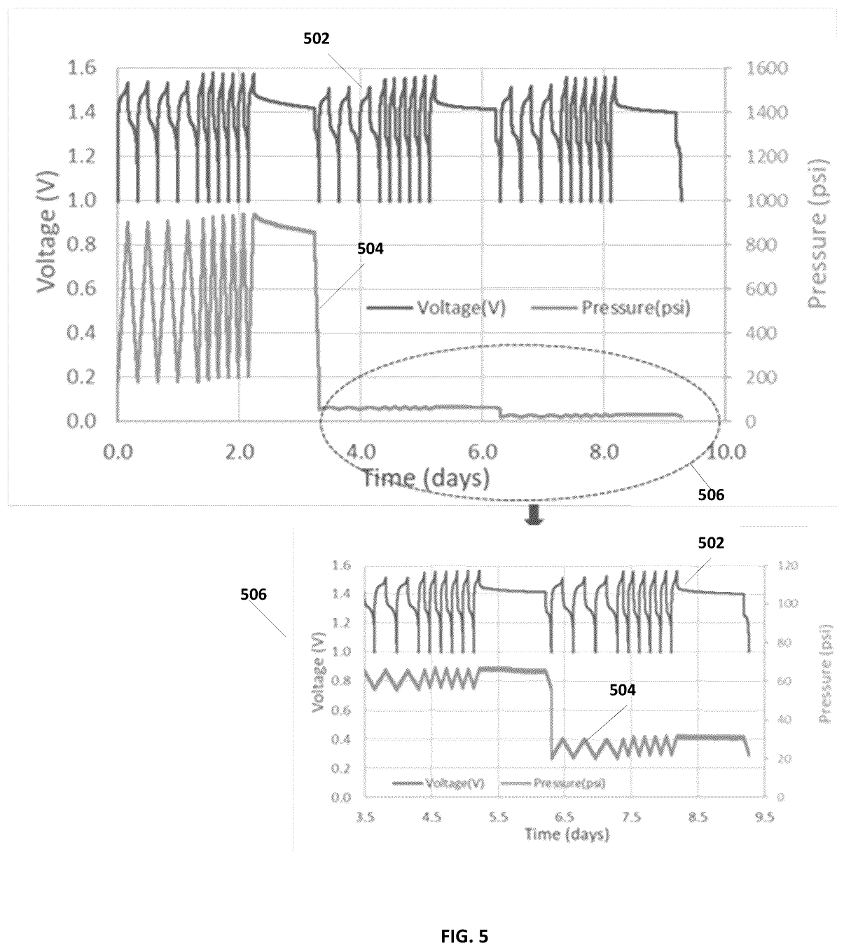

Battery 200 as described above can be operated at low hydrogen pressures. FIG. 5 illustrates a hydrogen pressure cycling profile at different pressure setups. In particular, FIG. 5 illustrates a voltage curve 502 for a battery as a function of time with a pressure curve 504 as a function of time for a battery according to some embodiments. Area 506 is expanded to illustrate operation of the battery at a much lowered pressure (e.g., 20-80 psi) as opposed to the 200-1000 psi operation otherwise illustrated. As is illustrated in FIG. 5, there is little difference in operation of the battery with high pressure and the operation of the battery with the low pressure in area 506.

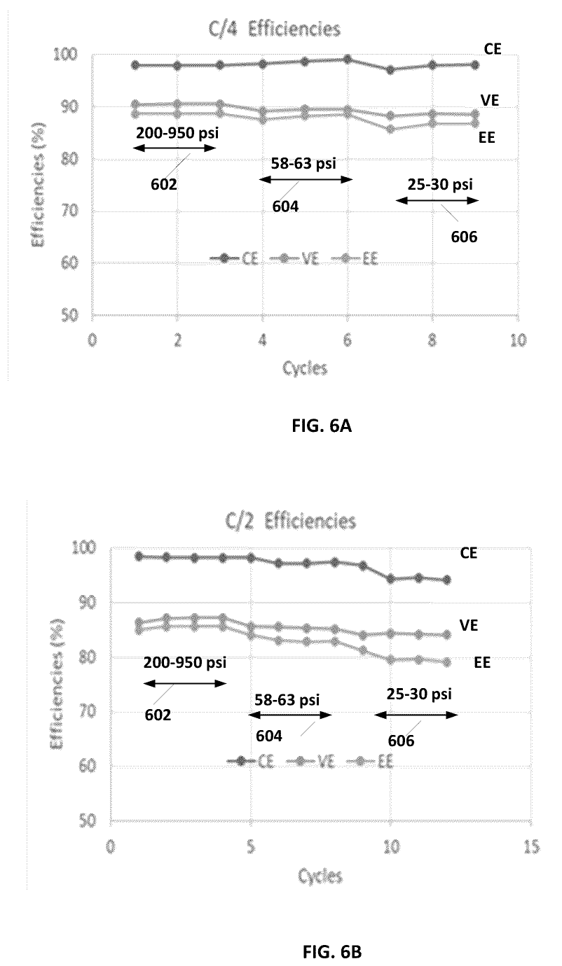

FIGS. 6A and 6B illustrate coulombic efficiency (CE), voltage efficiency (VE) and energy efficiency (EE) for a battery according to some embodiments over several ranges of hydrogen pressure. FIG. 6A illustrates C/4 efficiencies while FIG. 6B illustrates C/2 efficiencies. In particular, FIGS. 6A and 6B illustrate efficiencies in pressure range 602 of 200-950 psi, pressure range 604 of 58-63 psi, and pressure range 606 of pressure range 25-30 psi. As can be seen from FIGS. 6A and 6B, the efficiencies of the battery in the low pressure range 604 are substantially the same as those in the high pressure range 602. These efficiencies are also illustrated in Table I. As is illustrated, the efficiencies drop slightly in the lowest pressure range 606. Consequently, operation of the battery in the low pressure range 604, or even the lowest pressure range 606, can be used.

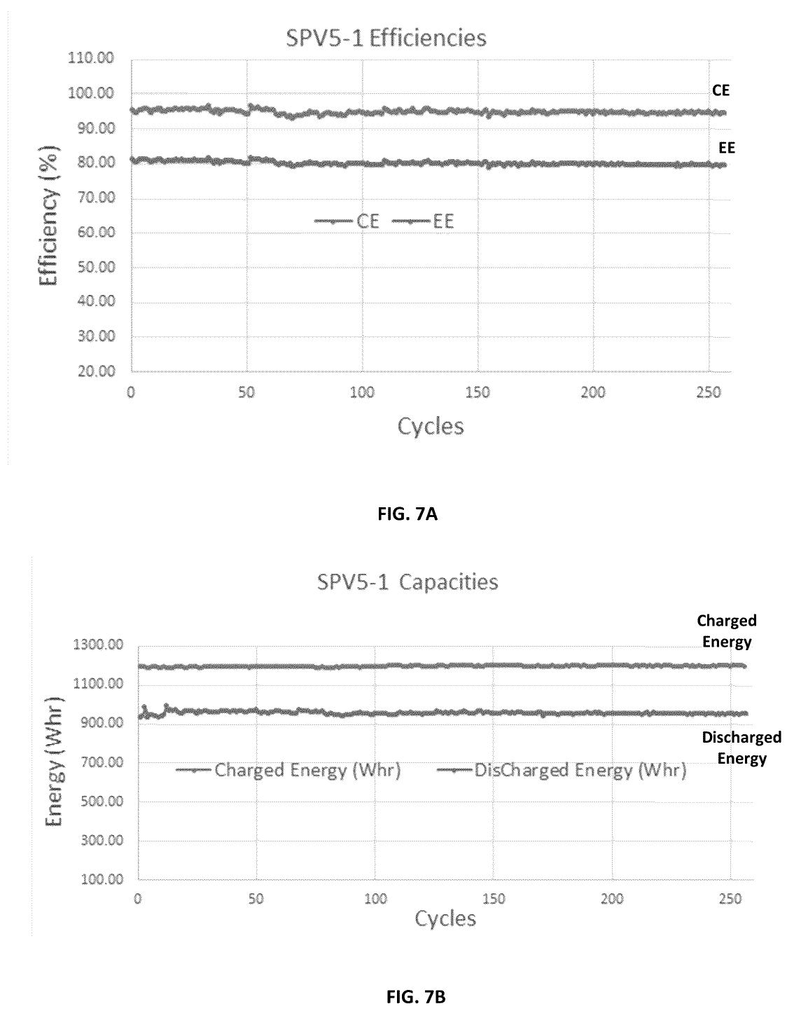

FIGS. 7A and 7B illustrates a five (5)-vessel shared pressure vessel (SPV) long term cycling performance at a hydrogen pressure of 50-150 psi. The SPV can be used in embodiments of the present disclosure. FIG. 7A illustrates CE and EE efficiencies for the SPV over 250 cycles and demonstrates consistent operation. FIG. 7B illustrates charged energy and discharge energy over 250 cycles and again demonstrates consistent operation.

TABLE I

| Pressure | | | | | | |
|---|---|---|---|---|---|---|
| range | | Chg | DChg | CE | VE | EE |
| (psi) | C rate | Cap(Ah) | Cap(Ah) | (%) | (%) | (%) |
| 200-950 | C/4 | 160 | 157 | 98 | 90 | 89 |
| 58-63 | | 160 | 158 | 99 | 89 | 88 |
| 25-30 | | 160 | 156 | 98 | 88 | 86 |
| 200-950 | C/2 | 160 | 157 | 98 | 87 | 85 |
| 58-63 | | 160 | 156 | 97 | 85 | 83 |
| 25-30 | | 160 | 152 | 95 | 84 | 80 |

As is illustrated above, one or more electrode stacks 230 can be arranged and operated at low pressure within facility 100 and operated at low hydrogen gas pressures (e.g. less than 500 psi, less than 200 psi, less than 100 psi, or less than 50 psi). This greatly reduces the high capital cost of pressure vessel formed by outer shell 104. Container 209, as discussed above, can be any material that allows hydrogen transport and prevents electrolyte flow. The low hydrogen pressure within facility 100 provides for practically built large-scale (2 MWh or larger storage facilities as illustrated in FIGS. 1A through 1D) energy storage facilities. Consequently, facility 100 can be constructed using conventional techniques with steel and pre-stressed concrete composite. Such a facility 100 can therefore meet applicable building codes and standards for the site on which facility 100 is constructed.

Aspects of the present disclosure describe an electrical storage facility. A selection of the multitude of aspects of the present disclosure can include the following aspects:

Aspect 1: An electrical storage facility, comprising: an outer shell, the outer shell containing a hydrogen gas; a battery pack rigidly mounted within the outer shell, the battery pack including an array of metal hydrogen batteries; and a monitor/control system coupled to each of the metal hydrogen batteries in the array of individual metal hydrogen batteries.

Aspect 2: The electrical storage facility of aspect 1, wherein each of the metal hydrogen batteries comprises: a container; and an electrode stack within the container, the electrode stack includes stacked cathode electrodes and anode electrodes separated by separators.

Aspect 3: The electrical storage facility of aspects 1-2, further including a plurality of electrode stacks within the container, each of the plurality of electrode stacks including stacked cathode electrodes and anode electrodes separated by separators.

Aspect 4: The electrical storage facility of aspects 1-3, wherein the electrode stack is saturated with an electrolyte and the container contains the electrolyte and is porous to the hydrogen gas.

Aspect 5: The electrical storage facility of aspects 1-4, wherein the battery pack operates at a low hydrogen pressure of the hydrogen gas.

Aspect 6: The electrical storage facility of aspects 1-5, wherein the low hydrogen pressure is less than 500 psi.

Aspect 7: The electrical storage facility of aspects 1-6, wherein the low hydrogen pressure is less than 200 psi.

Aspect 8: The electrical storage facility of aspects 1-7, wherein the low hydrogen pressure is less than 100 psi.

Aspect 9: The electrical storage facility of aspects 1-8, wherein the outer shell includes a liner that contains hydrogen gas.

Aspect 10: The electrical storage facility of aspects 1-9, wherein the outer shell is constructed with steel and stressed concrete.

Aspect 11: The electrical storage facility of aspects 1-10, wherein the battery pack provides energy storage greater than 2 GWh.

Aspect 12: The electrical storage facility of aspects 1-11, where the monitor/control is configured to monitor and control operation of each of the metal hydrogen batteries.

Aspect 13: A method of providing energy storage, comprising: providing an outer shell that contains a hydrogen gas; mounting a battery pack within the outer shell, the battery pack including an array of metal hydrogen batteries; and monitoring the battery pack with a monitor/control system coupled to each of the metal hydrogen batteries in the array of individual metal hydrogen batteries.

Aspect 14: The method of aspect 13, wherein each of the metal hydrogen batteries comprises: a container; and an electrode stack within the container, the electrode stack includes stacked cathode electrodes and anode electrodes separated by separators.

Aspect 15: The method of aspects 13-14, further including a plurality of electrode stacks within the container, each of the plurality of electrode stacks including stacked cathode electrodes and anode electrodes separated by separators.

Aspect 16: The method aspects 13-15, wherein the container contains an electrolyte and is porous to the hydrogen gas.

Aspect 17: The method of aspects 13-16, further including operating the battery pack at a low hydrogen pressure.

Aspect 18: The method of aspects 13-17, wherein the low hydrogen pressure is less than 500 psi.

Aspect 19: The method of aspects 13-18, wherein the low hydrogen pressure is less than 200 psi.

Aspect 20: The method aspects 13-19, wherein the low hydrogen pressure is less than 100 psi.

Aspect 21: The method of aspects 13-20, further including providing a liner that contains hydrogen gas to the outer shell.

Aspect 22: The method of aspects 13-21, wherein providing the outer shell includes constructing the outer shell with steel and stressed concrete.

Aspect 23: The method of aspects 13-22, wherein the battery pack provides energy storage greater than 2 GWh.

The foregoing description of the present disclosure has been provided for the purposes of illustration and description. It is not intended to be exhaustive or to limit the disclosure to the precise forms disclosed. The breadth and scope of the present disclosure should not be limited by any of the above-described exemplary embodiments. Many modifications and variations will be apparent to the practitioner skilled in the art. The modifications and variations include any relevant combination of the disclosed features. The embodiments were chosen and described in order to best explain the principles of the disclosure and its practical application, thereby enabling others skilled in the art to understand the disclosure for various embodiments and with various modifications that are suited to the particular use contemplated. It is intended that the scope of the disclosure be defined by the following claims and their equivalence.

What is claimed is:

1. An electrical storage facility, comprising:
an outer shell, the outer shell containing a hydrogen gas;
a battery pack rigidly mounted within the outer shell, the battery pack including an array of metal hydrogen batteries; and
a monitor/control system coupled to each of the metal hydrogen batteries in the array of individual metal hydrogen batteries.

2. The electrical storage facility of claim 1, wherein each of the metal hydrogen batteries comprises:
a container; and
an electrode stack within the container, the electrode stack includes stacked cathode electrodes and anode electrodes separated by separators.

3. The electrical storage facility of claim 2, further including a plurality of electrode stacks within the container, each of the plurality of electrode stacks including stacked cathode electrodes and anode electrodes separated by separators.

4. The electrical storage facility of claim 2 wherein the electrode stack is saturated with an electrolyte and the container contains the electrolyte and is porous to the hydrogen gas.

5. The electrical storage facility of claim 1, wherein the battery pack operates at a low hydrogen pressure of the hydrogen gas.

6. The electrical storage facility of claim 5, wherein the low hydrogen pressure is less than 500 psi.

7. The electrical storage facility of claim 5, wherein the low hydrogen pressure is less than 200 psi.

8. The electrical storage facility of claim 5, wherein the low hydrogen pressure is less than 100 psi.

9. The electrical storage facility of claim 1, wherein the outer shell includes a liner that contains hydrogen gas.

10. The electrical storage facility of claim 1, wherein the outer shell is constructed with steel and stressed concrete.

11. The electrical storage facility of claim 1, wherein the battery pack provides energy storage greater than 2 GWh.

12. The electrical storage facility of claim 1, where the monitor/control is configured to monitor and control operation of each of the metal hydrogen batteries.

13. A method of providing energy storage, comprising:
providing an outer shell that contains a hydrogen gas;
mounting a battery pack within the outer shell, the battery pack including an array of metal hydrogen batteries; and
monitoring the battery pack with a monitor/control system coupled to each of the metal hydrogen batteries in the array of individual metal hydrogen batteries.

14. The method of claim 13, wherein each of the metal hydrogen batteries comprises:
a container; and
an electrode stack within the container, the electrode stack includes stacked cathode electrodes and anode electrodes separated by separators.

15. The method of claim 14, further including a plurality of electrode stacks within the container, each of the plurality of electrode stacks including stacked cathode electrodes and anode electrodes separated by separators.

16. The method claim 15, wherein the container contains an electrolyte and is porous to the hydrogen gas.

17. The method of claim 13, further including operating the battery pack at a low hydrogen pressure.

18. The method of claim 17, wherein the low hydrogen pressure is less than 500 psi.

19. The method of claim 17, wherein the low hydrogen pressure is less than 200 psi.

20. The method claim 17, wherein the low hydrogen pressure is less than 100 psi.

21. The method of claim 13, further including providing a liner that contains hydrogen gas to the outer shell.

22. The method of claim 13, wherein providing the outer shell includes constructing the outer shell with steel and stressed concrete.

23. The method of claim 13, wherein the battery pack provides energy storage greater than 2 GWh.
